(19) United States
(12) Patent Application Publication
(10) Pub. No.: US 2009/0156727 A1
(43) Pub. Date: Jun. 18, 2009

(54) ELASTIC FIBERS HAVING REDUCED COEFFICIENT OF FRICTION

(76) Inventors: Selim Bensason, Au (CH); Benjamin C. Poon, Pearland, TX (US); Guido Bramante, Tarragona (ES)

Correspondence Address: The Dow Chemical Company, Intellectual Property Section, P.O. Box 1967, Midland, MI, 48641-1967, US

(21) Appl. No.: 11/719,604

(22) PCT Filed: Dec. 1, 2005
(86) PCT No.: PCT/US05/44943

§ 371 Date: May 17, 2007

Related U.S. Application Data
(60) Provisional application No. 60/632,925, filed on Dec. 3, 2004.

(51) Int. Cl. C08K 3/30; C08L 23/00; C08L 23/20; C08K 3/34; C08K 3/26; C08K 3/22

(52) U.S. Cl. 524/423; 524/570; 524/579; 524/451; 524/427; 524/432; 524/413

(57) ABSTRACT

The present invention relates to crosslinked, olefin elastic fibers having a reduced coefficient of friction. More particularly the invention relates to crosslinked, olefin elastic fibers containing organic or inorganic fillers. Still more particularly, the present invention relates to crosslinked, polyethylene based elastic fibers containing inorganic fillers.

The present invention relates to crosslinked, olefin elastic fibers having a reduced coeeficient of friction. More particularly the invention relates to crosslinked, olefin elastic fibers containing inorganic fillers. Still more particularly, the present invention relates to crosslinked, polyethylene based elastic fibers containing inorganic fillers.

Elastic fibers made from polyolefin materials and particularly crosslinked polyolefin materials, such as those disclosed in U.S. Pat. Nos. 5,824,717; 6,048,935; 6,140,442; 6,194,532; 6,437,014 and 6,500,540, have recently received much attention the field of textiles and apparel. The crosslinked, olefin elastic fibers include ethylene polymers, propylene polymers and fully hydrogenated styrene block copolymers (also known as catalytically modified polymers). The ethylene polymers include the homogeneously branched and the substantially linear homogeneously branched ethylene polymers as well as ethylene-styrene interpolymers. These crosslinked, olefin elastic fibers have been lauded for their chemical and heat resistance, their durability and their comfort stretch, and they are accordingly growing in popularity in both weaving and knitting applications.

Knitting with these elastic fibers involves incorporation of the elastic filaments into fabrics in stretched form. Consistency in stretch and the amount of stretch (draft) is achieved through use of positive unwinding or constant tension feeders for the elastic fibers. In circular knitting featuring positive unwinding devices (such as those produced by Memminger-IRO GmbH), the draft is controlled by the ratio of the delivery rate of the elastic fiber into the knitting machine relative to the delivery rate of the nonelastic or hard filament into the knitting machine. A fiber at a particular draft will have a cetain tension. The tension that is encountered between the feeding device and the guiding element will be lower due to friction at the guiding element. The amount of reduction is reflective of the frictional properties of the fiber against the guide element which can be quantified in terms of its dynamic coefficient of friction. High dynamic coefficient of friction leads to significant drops in tension which may cause a reduction in draft as well as fiber breaks. The dynamic coefficient of friction can be effected by surface characteristics of the fiber, surface characteristics of the machine guiding elements, and the geometry in the placement of the machine guiding elements. For example, there are different types of guiding elements used in circular knitting machines, including low friction pulleys, ceramic eyelets, ceramic tubes, etc., each with different geometries and coefficients of friction.

Polyolefin-based elastic fibers such as lastol, generally have higher dynamic coefficients of friction, making this problem particularly important for these fibers. Currently, for these fibers, the coefficient of friction may be reduced through the use of a finishing lubricant or “spin finish” applied to the surface of the fiber. Different spin finish formulations have been reported for use with elastic fibers such as metallic soaps dispersed in textile oils (see for example U.S. Pat. No. 3,039,895 or U.S. Pat. No. 6,652,599), surfactants in a base oil (see for example US publication 2003/0024052) and polyalkylsiolxanes (see for example U.S. Pat. No. 3,296,063 or U.S. Pat. No. 4,999,120).

While helpful, these spin finishes have not yet eliminated the problem and the friction coefficient at the guiding elements can still be fairly high, especially for eyelet or tube type guides. Therefore the draft and tension can still be fairly low in the zone between the unwinding device and the guides. This leads to several problems, including: lack of sufficient tension triggering the stop-motion pulley at the unwind device (designed to detect fiber breaks) which stops the machine, and irregularities in unwinding due to very low levels of takeup force that at times can be less than force needed to detach the filaments from the bobbins—thereby leading to fiber breaks. A reduced coefficient of friction at metal or ceramic guiding elements preceding the needle-bed would result in an increased retention of the fiber tension between the bobbin and the needle-bed and resolves both of these problems.

It has been discovered that including one or more inorganic fillers such as talc, synthetic silica, precipitated calcium carbonate, zinc oxide, barium sulfate and titanium dioxide into the polymer prior to spinning the fiber, reduces the dynamic coefficient of friction. This effect is improved by combining the use of inorganic fillers with the use of a spin finish.

Accordingly, one aspect of the present invention is an elastic fiber comprising a crosslinked olefin polymer having up to 5 percent by weight of one or more inorganic fillers. These materials can conveniently be melt compounded into the polymeric material prior to spinning the fiber.

The fibers of the present invention are preferably coated with a spin finish such as silicone oils.

The fibers of the present invention not only demonstrate reduced dynamic coefficients of friction, but they may also show improved tenacity and allow improved electron-beam yield when an electron beam is used for crosslinking. Furthermore, die-buildup may also be reduced when using olefin material having inorganic fillers therein, and opacity may be increased, which is generally desired in applications where the fiber is used in bare form.

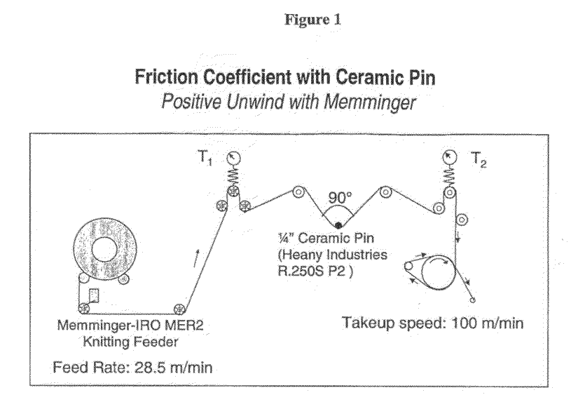

FIG. 1 is a schematic of the Electronic Constant Tension Transporter unit (“ECTI”) used in Dynamic Fiber-Ceramic Pin Friction Test as described below.

For purposes of this invention the following terms shall have the given meanings:

“Polymer” means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, for example, a polymer comprising propylene and ethylene, the polymer, of course, comprises units derived from the monomers, for example, —CH₂—CH₂—, and not the monomer itself, for example, CH₂═CH₂.

“Fiber” means a material in which the length to diameter ratio is greater than about 10. Fiber is typically classified according to its diameter. Filament fiber is generally defined as having an individual fiber diameter greater than about 15 denier, usually greater than about 30 denier. Fine denier fiber generally refers to a fiber having a diameter less than about 15 denier. Microdenier fiber is generally defined, as fiber having a diameter less than about 100 microns denier.

“Filament fiber” or “monofilament fiber” means a single, continuous strand of material of indefinite (that is, not predetermined) length, as opposed to a “staple fiber” which is a discontinuous strand of material of definite length (that is, a strand which has been cut or otherwise divided into segments of a predetermined length).

“Homofilament fiber” means a fiber that has a single polymer region or domain over its length, and that does not have any other distinct polymer regions (as does a bicomponent fiber). “Bicomponent fiber” means a fiber that has two or more distinct polymer regions or domains over its length. Bicomponent fibers are also know as conjugated or multicomponent fibers. The polymers are usually different from each other although two or more components may comprise the same polymer. The polymers are arranged in substantially distinct zones across the cross-section of the bicomponent fiber, and usually extend continuously along the length of the bicomponent fiber. The configuration of a bicomponent fiber can be, for example, a cover/core (or sheath/core) arrangement (in which one polymer is surrounded by another), a side by side arrangement, a pie arrangement or an “islands-in-the sea” arrangement. Bicomponent or conjugated fibers are further described in U.S. Pat. Nos. 6,225,243, 6,140,442, 5,382,400, 5,336,552 and 5,108,820.

“Elastic” means that a fiber will recover at least about 50 percent of its stretched length after the first pull and after the fourth to 100 percent strain (doubled the length). Elasticity can also be described by the “permanent set” of the fiber. Permanent set is the converse of elasticity. A fiber is stretched to a certain point and subsequently released to the original position before stretch, and then stretched again. The point at which the fiber begins to pull a load is designated as the percent permanent set.

“Filler” means a solid material capable of changing the physical and chemical properties of materials by surface interaction or its lack thereof and/or by its own physical characteristics. Filler can be inorganic or organic. An example of organic filler is wood filler. Inorganic filler is generally preferred for use in the present invention.

In one aspect, the present invention is an elastic fiber comprising a crosslinked olefin polymer having up to 5 percent by weight of one or more organic or inorganic fillers.

The olefin polymer for use in the present invention can be any olefin based material capbable of forming a fiber, including ethylene-alpha olefin interpolymers, substantially hydrogenated block polymers, propylene alpha olefin interpolymers (including propylene ethylene copolymers), styrene butadiene styrene block polymers, styrene-ethylene/butene-styrene block polymers, ethylene styrene interpolymers, polypropylenes, polyamides, polyurethanes and combinations thereof. The homogeneously branched ethylene polymers described in U.S. Pat. No. 6,437,014, particularly the substantially linear ethylene polymers, are particularly well suited for use in this invention.

Prior to forming the fiber, a filler material is added to the polymer in an amount of at least 0.1 percent by weight of the compounded material, preferably at least 0.25, more preferably at least 0.5 percent of the compounded material. As too much filler is thought to lead to problems in bulging and spinnability, it is preferred that the inorganic filler comprise less than five percent by weight of the compounded material, preferably less than four, more preferably less than three percent of the compounded material. The optimal range of the filler will depend upon the size distribution as wellas the specific gravity of the inorganic filler.

The filler can be any solid material capable of changing the physical and chemical properties of materials by surface interaction or its lack thereof and/or by its own physical characteristics. Preferably, the filler is an inorganic filler. More preferably the inorganic filler is selected from the group comprising talc, synthetic silica, precipitated calcium carbonate, zinc oxide, barium sulfate and titanium oxide. Talc is the most preferred filler for use in the present invention.

The size of the filler material can also be optimized for the desired application. In general the mean particle size should be less than about 10 microns. Filler having a mean particle size of as little as 0.1 microns has been observed to be effective for usein the present invention, and it is possible that even smaller particle sizes may also be effective. For non-circular particles, the equivalent circular partical size is calculated, as is generally known in the art (essentially a 2 diminsional image is made of the 3 diminsional object, the area of this shadow is determined and a circle having the same area is given as the equivalent circular partical size). Likewise, the shape of the filler can also be varied for different effects, although the shape may largely be determined by the choice of filler (that is, the filler chosen will tend to have a characteristic shape).

Any means of incorporating the inorganic filler into the olefin polymer may be used in this invention. Most conveniently, the inorganic filler is melt compounded into the polymer. Alternatively the filler can be added neat or as a masterbatch just prior to spinning.

The fibers can be formed by many processes known in the art, for example the fibers can be meltblown or spunbond. Fibers lacking inorganic filler, but otherwise suitable for use in the present invention are disclosed in U.S. Pat. No. 6,437,014. As seen in that reference, the fibers can vary in thickness with fibers of 10 to 400 denier being most preferred.

Furthermore the fibers are preferably homofilament fibers but can be conjugate fibers. In the case of conjugate fibers it is preferred that the inorganic filer material be located at least in the material which makes up at least a portion of the surface of the fiber, so as to obtain the benefits of the reduction of the dynamic coefficient of friction. Likewise, while the benefit of reduced dynamic coefficient of friction is greatest for monofilament fiber, it is also possible for the fibers of the present invention to be staple fibers. It is also conceivable that two or more monofilament fibers may be joined to form a

After they have been formed, the fibers of the present invention are preferably coated with a spin finish known in the art, such as silicone oils. The finishes can be applied to the fiber by dipping, padding, spraying, finish rolls or by addition to the compounded polymer for simultaneous extrusion with the fiber-forming polymer. The finishes usually amount to between 0.25 and 3 percent of the weight of the filament to which they are applied.

The fibers of the present invention may be used neat (or bare) or may be combined into a yarn with an inelastic fiber such as cotton, wool, or synthetic material such as polyester or nylon. However, the benefits of reduced dynamic coefficient of frictions are most pronounced when the fiber is neat.

The fibers, whether neat or used with other material in a yarn, may be used alone or together with other yarns to make textiles according to known fabrication methods such as weaving or knitting. The fibers of the present invention are particularly well suited for knitting applications.

### EXAMPLES

Fiber Production

The following examples were carried out in order to demonstrate the effectiveness of the fibers of the present invention. In these Examples the base resin was an ethylene-octene copolymer with 0.875 g/cc density as determined by ASTM D-792 and 3 MI as determined according to ASTM D-1238, Condition 190° C./2.16 kg (formally known as “Condition (E)” and also known as I₂). The resin was compounded to add 3000 ppm of Cyanox 1790, 3000 ppm Chimassorb 944 and 7000 ppm PDMSO as processing aid. For filled fibers, talc and TiO₂ were also added in the compounding step to give a final concentration of 0.5 wt percent talc and 0.5 wt percent TiO₂. The talc was an Ampacet masterbatch, 100165-C, at 50 wt percent in LLDPE of 0.924 g cm⁻³ density and 20 MI. It was a zinc stearate coated grade with an average particle size of 5 μm, as indicated by product literature. The TiO₂ was an Ampacet masterbatch, 11078, at 50 percent wt in an LDPE of 0.92 g cm⁻³ density and 8 MI. The product sheet indicates that the TiO₂ is coated rutile form with an average particle size of 0.20-0.25 μm.

Monofilament fibers of 40 denier were melt spun into 300 g bobbins. A spin finish of Lurol 8517 (Goulstron Technologies) was applied at 2 wt percent to the surface of the fiber via a spin finish applicator after the fiber had solidified from the melt.

### Example 1

### Dynamic Fiber-Ceramic Pin Friction Test

The frictional property of the fibers was measured using a method such that it simulates an elastic fiber passing through a guide during knitting. For comparison, a commercial spandex fiber (40 denier Dorlastan v850) was included in the study. All measurements were taken with an instrumented Electronic Constant Tension Transporter unit (“ECTT”) from Lawson Hemphill. A schematic of the setup is shown in FIG. 1. The ECTT consists of a feed roll and a take-up roll controlled independently by a computer. A feeder (Memminger—IRO MENR2) typically used in large diameter circular knitting machines for use with spandex elastic fibers was attached to the ECTT and was driven by the feed roll of the ECTT via a drive belt. The bobbin was unwound at 28.5 m/min and taken up at 100 m/min, giving a total draft of 3.5×. As the fiber was unwound, it passed across a ¼ inch diameter ceramic pin (Heany Industries—R.250S P2) at a 90° wrap angle. The ceramic pin had a surface roughness of 32 rms as measured by the manufacturer. Load was measured before and after the ceramic pin using two 100 cN tensiometers (Rothschild—Perma-Tens 100p/100cN). From the ratio of the two tensions, and the wrap angle, the dynamic friction coefficient was calculated using the Euler formula:

$$\frac{{T}_{2}}{{T}_{1}} = {e}^{μ θ}$$

where μ is the friction coefficient, T₂ is the tension after the pin, T₁ is the tension before the pin, and θ is the wrap angle (π/2). A scan of 5 minutes was taken. In all friction measurements, all guiding elements and rollers in contact with the fiber, as well as friction pin were cleaned with isopropyl alcohol prior to each run to eliminate any deposit buildup.

The results of the dynamic friction test are listed in Table 1. The data show that the addition of talc and TiO₂ significantly lowered the coefficient of friction from 0.66 to 0.39, which was fairly close that measured for spandex (Dorlastan v850).

TABLE 1

| Fiber | COF |
|---|---|
| Spandex (Dorlastan v850) | 0.32 |
| Control Fiber (No Fillers) | 0.66 |
| Filled Fiber (0.5% Talc and 0.5% TiO₂) | 0.39 |

### Example 2

The frictional response of fibers was also evaluated in circular knitting. A Mayer circular knitting machine (1988) of 30 inch diameter and 28 gauge with 96 elastic feeders (MER-2 Iro) was used in this experiment. A texturized polyamide of 70/2 denier was used as companion fiber. The speed of the machine was set at 22 rpm, with the hard yarn feeding rate of 155 m/min, and an elastic feeding rate of 43 m/min, resulting in an elastic draft of 3.6×.

The components and geometrical configuration of the yarn carriers used to feed the elastic fiber into the needle bed, has an influence on frictional resistance encountered by the fiber prior to its entry into the needles. Two distinct types of elastic yarn carriers were evaluated:

(a) Type A: Ceramic eyelet followed by steel locator

(b) Type B: Plastic free rotating pulley followed by steel guide

Elastic fiber tension in the region preceding the carrier was measured by a Zivy tension-meter and is reported in Table II as T_{A} and T_{B} for the respective carriers. This was compared to the dynamic tension for each fiber at 3.6× draft in the absence of any frictional obstruction, as measured with an ECTT unit as described in Example 1 with the ceramic pin removed, feeding the fiber at a rate of 43 m/min by a MER-2 device at a takeup rate of 155 m/min. The T_{A} and T_{B} tension will always be somewhat lower than the tension measured in the absence of any frictional obstruction at the same draft, due to the frictional interaction of the fiber with the yarn carrier. The ratio of both tensions is related to the effective coefficient of friction between the fibers and the yarn carrier assembly. As should be readily understood by a person of ordinary skill in the art, ratios closer to 1 indicate less friction.

The tensions measured with the tensionmeter at the knitting machine for three different types of fibers fed through two different types of carriers is shown in Table II. The tension readings represent the average values for 10 bobbins, each measured for one minute. Also shown in Table II is the average dynamic tension value measured with the ECTT for the three fibers, with a five minute scan. In this example, the spandex used was Lycra 136B of 40 den.

TABLE II

| | ECTT | Type A | | Type B | |
|---|---|---|---|---|---|
| | Tension | Carrier | | Carrier | |
| Fiber | T (gf) | T_{A} (gf) | T/T_{A} | T_{B} (gf) | T/T_{B} |
| Spandex (Lycra 136B) | 12.5 | 6.3 | 2.0 | 8.2 | 1.5 |
| Control Fiber (No Fillers) | 6.5 | 2.3 | 2.8 | 3.0 | 2.2 |
| Filled Fiber (0.5% Talc | 6.3 | 3.3 | 1.9 | 4.3 | 1.5 |
| and 0.5% TiO₂) | | | | | |

What is claimed is:

1. A fiber comprising a crosslinked olefin polymer and from 0.1 to 5 percent by weight of one or more organic or inorganic fillers.

2. The fiber of claim 1 wherein the crosslinked olefin polymer comprises a polyethylene/alpha olefin copolymer.

3. The fiber of claim 2 wherein the polyethylene/alpha olefin copolymer is an ethylene/octene copolymer.

4. The fiber of claim 1 wherein the filler is an inorganic filler.

5. The fiber of claim 4 wherein the inorganic filler is selected from the group consisting of talc, synthetic silica, precipitated calcium carbonate, zinc oxide, barium sulfate and titanium dioxide and mixtures thereof.

6. The fiber of claim 5 wherein the inorganic filler is talc.

7. The fiber of claim 1 wherein the organic or inorganic filler has an average particle diameter in the range of 0.1 to 5 microns.

8. The fiber of claim 1 wherein the organic or inorganic filler has a generally spherical shape.

9. The fiber of claim 1 wherein the organic or inorganic filler comprises from 0.25 to 4 percent by weight of the fiber.

10. The fiber of claim 1 wherein the organic or inorganic filler comprises from 0.5 to 3 percent by weight of the fiber.

11. The fiber of claim 1 further comprising a lubricant on the surface of the fiber.

12. The fiber of claim 11 wherein the lubricant is a silicone oil.

13. The fiber of claim 1 wherein the fiber is an elastic fiber.

14. A method for improving the dynamic coefficient of elastic fibers comprising an olefin polymer, said method comprising adding one or more organic or inorganic fillers into the olefin polymer prior to forming the fiber.

15. The method of claim 14 wherein the organic or inorganic filler is melt compounded into the olefin polymer.

16. The method of claim 14 wherein the filler in inorganic and is selected from the group consisting of talc, synthetic silica, precipitated calcium carbonate, zinc oxide, barium sulfate and titanium dioxide and mixtures thereof.

17. The method of claim 16 wherein the inorganic filler is talc.

18. The method of claim 14 wherein the inorganic filler has an average particle diameter in the range of 0.1 to 5 microns.

19. The method of claim 14 wherein the inorganic filler has a generally spherical shape.

20. The method of claim 14 wherein the inorganic filler comprises from 0.1 to five percent by weight of the fiber.
